(19) United States
(12) Patent Application Publication
(10) Pub. No.: US 2004/0227994 A1
(43) Pub. Date: Nov. 18, 2004

(54) Polarizing beam splitter and projection systems using the polarizing beam splitter

(76) Inventors: Jiaying Ma, Maplewood, MN (US); Charles L. Bruzzone, Woodbury, MN (US); William W. Merrill, White Bear Lake, MN (US); David J. W. Aastuen, Shoreview, MN (US)

Correspondence Address: 3M INNOVATIVE PROPERTIES COMPANY, PO BOX 33427, ST. PAUL, MN, 55133-3427, US

(21) Appl. No.: 10/439,444

(22) Filed: May 16, 2003

(51) Int. Cl. G02B 5/30

(52) U.S. Cl. 359/487; 359/500

(57) ABSTRACT

A polarizing beam splitter (PBS) includes a first multilayer reflective polarizing film and a second multilayer reflective polarizing film disposed between two covers. The two multilayer reflective polarizing films can be the same or different. The PBS can be used in a variety of applications.

### TECHNICAL FIELD

The present invention is directed generally to polarizing beam splitters and the use of such devices in, for example, systems for displaying information, and more particularly to reflective projection systems.

### BACKGROUND

Optical imaging systems typically include a transmissive or a reflective imager, also referred to as a light valve or light valve array, which imposes an image on a light beam. Transmissive light valves are typically translucent and allow light to pass through. Reflective light valves, on the other hand, reflect only selected portions of the input beam to form an image. Reflective light valves provide important advantages, as controlling circuitry may be placed behind the reflective surface and more advanced integrated circuit technology becomes available when the substrate materials are not limited by their opaqueness. New potentially inexpensive and compact liquid crystal display (LCD) projector configurations may become possible by the use of reflective liquid crystal microdisplays as the imager.

Many reflective LCD imagers rotate the polarization of incident light. In other words, polarized light is either reflected by the imager with its polarization state substantially unmodified for the darkest state or with a degree of polarization rotation imparted to provide a desired grey scale. A 90° rotation provides the brightest state in these systems. Accordingly, a polarized light beam is generally used as the input beam for reflective LCD imagers. A desirable compact arrangement includes a folded light path between a polarizing beamsplitter (PBS) and the imager, wherein the illuminating beam and the projected image reflected from the imager share the same physical space between the PBS and the imager. The PBS separates the incoming light from the polarization-rotated image light. A conventional PBS used in a projector system, sometimes referred to as a MacNeille polarizer, uses a stack of inorganic dielectric films placed at Brewster's angle. Light having s-polarization is reflected, while light in the p-polarization state is transmitted through the polarizer.

A single imager may be used for forming a monochromatic image or a color image. Multiple imagers are typically used for forming a color image, where the illuminating light is split into multiple beams of different color. An image is imposed on each of the beams individually, which are then recombined to form a full color image.

### SUMMARY

Generally, the present invention relates to an apparatus for reducing haze in a projection system. In particular, the invention is based around an imaging core that includes haze reduction in the polarizing beamsplitter.

The present invention provides a PBS that includes a first multilayer reflective polarizing film and a second multilayer reflective polarizing film. The combination of first and second films is preferably selected to be stable in blue light although other films and combinations can be used. The use of such combination can also provide the resulting polarizer with increased contrast over the entire visible range.

The use of two (or more) films in the PBS construction of the present invention decreases the haze reaching the projection screen. The two film construction may be used with any material as covers (e.g., prisms). Such materials include glass. The glass can have any index of refraction although the index typically ranges from 1.4 to 1.8 and can be in the range of 1.4 to 1.6. This lower index glass may decrease astigmatism. Despite the use of an additional film in the PBS, p-polarized light transmission through the PBS is not dramatically reduced.

One embodiment of the present invention provides a polarizing beamsplitter that includes a first multilayer reflective polarizing film that includes a plurality of layers. The plurality of layers of the first multilayer reflective polarizing film has a first distribution of optical thicknesses. The polarizing beamsplitter also includes a second multilayer reflective polarizing film proximate the first multilayer reflective polarizing film, where the second multilayer reflective polarizing film includes a plurality of layers. The plurality of layers of the second multilayer reflective polarizing film has a second distribution of optical thicknesses, where the second distribution is different than the first distribution. A major surface of the second multilayer reflective polarizing film faces a major surface of the first multilayer reflective polarizing film. The polarizing beamsplitter also includes covers disposed on either side of the first and second multilayer reflective polarizing films. An optical adhesive can be provided between the first multilayer reflective polarizing film and the second multilayer reflective polarizing film. In one embodiment, the first multilayer reflective polarizing film includes a first contrast ratio spectrum and the second multilayer reflective polarizing film includes a second contrast ratio spectrum. The first contrast ratio spectrum may be different from the second contrast ratio spectrum.

Another embodiment of the present invention is directed to a polarizing beamsplitter including a first multilayer reflective polarizing film and a second multilayer reflective polarizing film. The second multilayer reflective polarizing film is proximate the first multilayer reflective polarizing film. A major surface of the second multilayer reflective polarizing film faces a major surface of the first multilayer reflective polarizing film. The polarizing beamsplitter also includes covers disposed on either side of the first and second multilayer reflective polarizing films.

Another embodiment of the present invention is directed to a projection system that includes a light source to generate light and conditioning optics to condition the light from the light source. The system further includes an imaging core to impose an image on conditioned light from the conditioning optics to form image light, where the image core includes at least one polarizing beamsplitter and at least one imager. The polarizing beamsplitter includes a first multilayer reflective polarizing film and a second multilayer reflective polarizing film proximate the first multilayer reflective polarizing film, where a major surface of the second multilayer reflective polarizing film faces a major surface of the first multilayer reflective polarizing film. The polarizing beamsplitter also includes covers disposed on either side of the first and second multilayer reflective polarizing films. The system further includes a projection lens system to project the image light from the imaging core. In one embodiment, the system also includes a controller coupled to the at least one imager to control the image imposed on light incident on the at least one imager. In another embodiment, the system may also include a color separator disposed between the polarization beamsplitter and the at least one imager.

Another embodiment of the present invention is directed to a method of making a polarizing beamsplitter that includes forming a first multilayer reflective polarizing film; forming a second multilayer reflective polarizing film; placing a major surface of the second multilayer reflective polarizing film opposite a major surface of the first multilayer reflective polarizing film; and placing the first and second multilayer reflective polarizing films between two covers.

Other features and advantages of the invention will be apparent from the following description and drawings, and from the claims.

### BRIEF DESCRIPTION OF THE DRAWINGS

The invention may be more completely understood in consideration of the following detailed description of various embodiments of the invention in connection with the accompanying drawings, in which:

FIG. 1 schematically illustrates an embodiment of a PBS having a first multilayer reflective polarizing film and a second multilayer reflective polarizing film;

FIG. 2 schematically illustrates an embodiment of a projection unit based on a single reflective imager;

FIG. 3 schematically illustrates another embodiment of a projection unit based on multiple reflective imagers;

FIG. 4 is a graph of contrast plotted against wavelength for a PBS having a first and second multilayer reflective polarizing film, both alone and in combination;

FIG. 5 is a graph of transmission of p-polarized light plotted against wavelength for a PBS having a first and second multilayer reflective polarizing film, both alone and in combination; and

FIG. 6 is a graph of contrast plotted against wavelength for a PBS having a first and second multilayer reflective polarizing film, both alone and in combination.

### DETAILED DESCRIPTION

The present invention is applicable to optical imagers and is particularly applicable to large numerical aperture optical imager systems that may produce high quality, low aberration, projected images.

One exemplary type of optical image system includes a wide-angle Cartesian polarization beamsplitter (PBS), as discussed in U.S. Pat. No. 6,486,997 B1, entitled REFLECTIVE LCD REFLECTION SYSTEM USING WIDE-ANGLE CARTESIAN POLARIZING BEAM SPLITTER. A Cartesian PBS is a PBS in which the polarizations of transmitted and reflected beams are referenced to invariant, generally orthogonal, principal axes of the PBS film. In contrast, with a non-Cartesian PBS, the polarization of the separate beams is substantially dependent on the angle of incidence of the beams on the PBS.

An example of a Cartesian PBS is a multilayer reflective polarizing (MRP) film, which can be exemplified by a film that is formed from alternating layers of isotropic and birefringent material. If the plane of the film is considered to be the x-y plane, and the thickness of the film is measured in the z-direction, then the z-refractive index is the refractive index in the birefringent material for light having an electric vector parallel to the z-direction. Likewise, the x-refractive index is the refractive index in the birefringent material for light having its electric vector parallel to the x-direction, and the y-refractive index is the refractive index in the birefringent material for light having its electric vector parallel to the y-direction. For the MRP film, the y-refractive index of the birefringent material is substantially the same as the refractive index of the isotropic material, whereas the x-refractive index of the birefringent material is different from that of the isotropic material. If the layer thicknesses are chosen appropriately, the film reflects visible light polarized in the x-direction and transmits light polarized in the y-direction.

One example of a useful MRP film is a matched z-index polarizer (MZIP) film, in which the z-refractive index of the birefringent material is substantially the same as the y-refractive index of the birefringent material. Polarizing films having a matched z-index have been described in U.S. Pat. Nos. 5,882,774 and 5,962,114, and in the following co-assigned U.S. Patent Applications: 60/294,940, filed May 31, 2001; 2002-0190406, filed May 28, 2002; 2002-0180107, filed May 28, 2002; Ser. No. 10/306,591, filed Nov. 27, 2002; and Ser. No. 10/306,593, filed Nov. 27, 2002. Polarizing films having a matched z-index are also described in U.S. patent application Ser. No. 09/878,575, filed Jun. 11, 2001, entitled

Polarizing Beam Splitter.

In some instances, polarizing beamsplitters that use MRP or MZIP films may produce haze. Haze may reduce the contrast of the imager system and also cause a dark state non-uniformity because the PBS is neither at the object nor the pupil location. One potential cause of haze may be discrete, colored points of light observed upon illumination of the MRP film. These points of light appear to be localized leaks of x-polarized light, which is substantially the same as s-polarized light. Such leaks may be caused by disruptions in the layer structure of the MRP film caused by particulates, localized voids or delamination in the film layers, crystallites, flow instabilities during co-extrusion, or other defects in the film.

Since the haze is polarized in only one direction (i.e., the direction that the PBS should reflect (s-polarized)) it may be eliminated with a clean-up post-polarizer oriented to pass the desired pass state light (p-polarized). A perfect clean-up post-polarizer (CUPP), in principle, does not degrade the projected image. However, in practice, the use of a CUPP may cause a 10% to 15% loss of brightness in the projected image. A CUPP also adds to the cost and complexity of the projection system.

Further, a MRP film used in either blue or white light is preferably made of materials that do not degrade when illuminated in the blue. Examples of such MRP films can be found in U.S. patent application Ser. No. 09/878,575. This preference in materials can hinder the use of the highest birefringence resins in MRP films, which in turn may make it more challenging to make a high contrast, broad-spectrum MRP film. MRP films for blue or white light that utilize materials that do not degrade in blue light are placed in a very high index glass cubic prism, causing the angles of transmission through the film to increase, which in turn increases the interfacial reflectance at each film layer interface. In this way, very high reflection of s-polarized light can be achieved despite the low birefringence of the high index layers.

The contrast of PBS made with MRP films depends on several parameters, including, for example, index difference along the mismatched direction (e.g., x-direction), the degree of index matching in the in-plane match direction (e.g., y direction), the degree of index matching in the thickness direction (e.g., z direction), and the total number of layers of the films. The index difference between layers along the mismatched direction and the index matching along matched direction(s) is limited by the polymer resin pairs. Moreover, the polymer resins are preferably substantially transparent in the visible spectral range (or whatever spectral range will be of interest in the PBS application) from blue to green to red light. One such pair is described below in the Examples and includes PET and a copolymer of PET (coPET). These polymers are substantially transparent over the entire visible wavelength range, including the blue light. However, the index difference of these polymers along the mismatched direction is only about 0.15. To achieve a desired level of contrast in an optical system as described below, an MZIP film using this combination of polymers typically uses a pair of high index glass prisms.

Two effects can occur when high index glass is used with the PBS film: generation of astigmatism in the PBS, and an increase in uncompensated mirror dark state brightness.

An approach to eliminating astigmatism is described in co-assigned U.S. patent application Ser. No. 09/878,559, filed Jun. 11, 2001, and Ser. No. 10/159,694, filed May 29, 2002, both entitled PROJECTION SYSTEM HAVING LOW ASTIGMATISM. These applications describe the use of a very high index glass plate next to the film to compensate for astigmatism. However, this plate may add significant cost to the PBS. Further, use of such a plate may cause a longer back focal length and a more difficult lateral color situation for the projection lens. In addition, a PBS having a compensation plate can require a larger color combiner cube.

Further, high index PBS glass causes light to propagate at very high angles into the PBS film. If a glass with a refractive index below 1.6 is used for the PBS, then the contrast for the uncompensated mirror dark state is typically about the same as the contrast obtained with an oriented quarter wave film (QWF) disposed over the mirror. As used herein, the term “uncompensated mirror dark state” is defined as the dark state obtained when a bare mirror is used in place of the imager in an imaging system, such as those described below, and the resulting light transmission through the imaging system is observed. When the index of the glass is increased to 1.85, the value of the uncompensated mirror dark state is reduced to less than half the contrast with the QWF disposed over the mirror, particularly when an index matching layer is used to match the high birefringence glass prisms to the MRP film and thereby reduce reflections. This loss in contrast can be reclaimed by placing a QWF over the mirror or imager that is aligned with its fast axis along the polarization direction of the incoming light. However, these special compensation plates (e.g., QWF) may increase cost and can be difficult to align properly. Therefore, a technique for using a PBS film in a low index glass (e.g., n<1.60) would decrease cost by eliminating the need for mirror dark state compensation plates such as QWF.

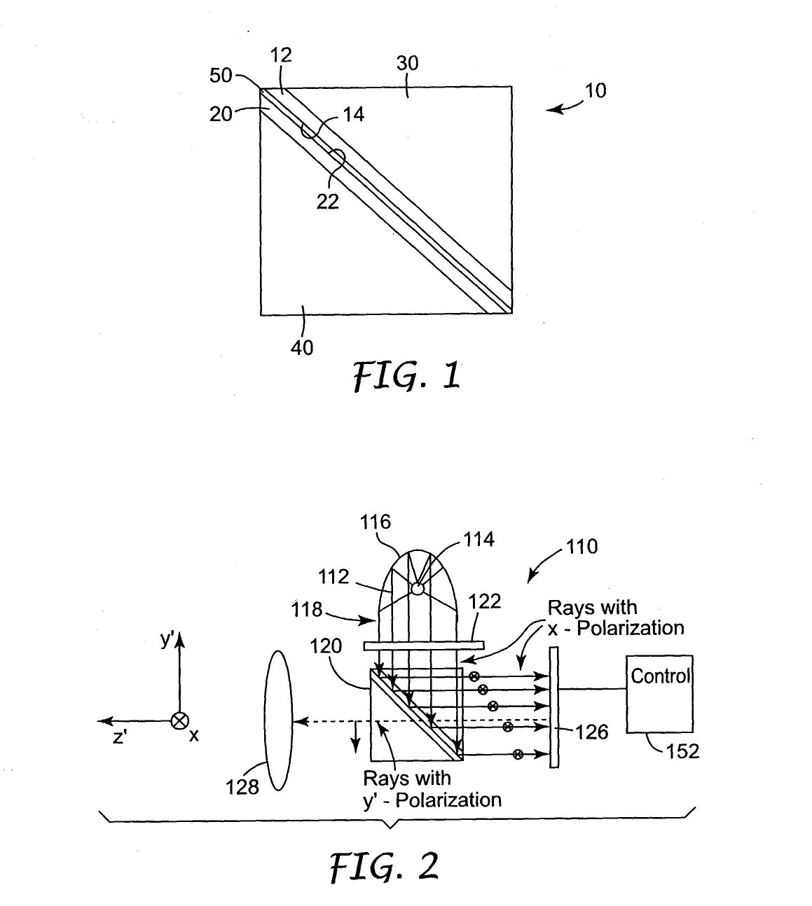

FIG. 1 illustrates one embodiment of a polarizing beamsplitter 10 that uses two or more multilayer reflective polarizing (MRP) films according to the present invention. In this embodiment, polarizing beamsplitter 10 includes a first multilayer reflective polarizing film 12, a second multilayer reflective polarizing film 20, and an optional layer 50 between the first film 12 and the second film 20. One or both of the first and second films 12 and 20 may be any suitable MRP film known in the art, preferably MZIP films. Although PBS 10 includes first and second films 12 and 20 respectively, three or more films may also be utilized.

Suitable MRP films include those described in U.S. Pat. No. 5,882,774. One embodiment of a suitable MRP film includes alternating layers of two materials, at least one of which is birefringent and oriented. Films which function well in glass prisms can have additional features to provide appropriate values of the anisotropic indices of refraction for each layer, especially in the direction normal to the surface of the film. Specifically, the indices of refraction in the thickness direction of the film of the alternating layers are ideally matched. This is in addition to the indices in the y-direction (pass direction) of the polarizer being matched. For a polarizer to have high transmission along its pass axis for all angles of incidence, both the y and z (normal to the film) indices of the alternating layers may be matched. Achieving a match for both the y and z indices may utilize a different material set for the layers of the film than that used when only the y index is matched. Older 3M multi-layer films, such as 3M brand “DBEF” film, were made in the past with a match to the y index.

One technique for matching both the y and z indices of all the layers is to impart a true uniaxial stretch where the film is allowed to relax (i.e., shrink) in both the y and z directions while it is being stretched in the x direction. In such a manner, the y and z indices of refraction are the same in a given layer. It then follows that if a second material is chosen that matches the y index of the first material, the z indices must also match because the second material layers are also subjected to the same stretching conditions.

In general, the mismatch in index between the y indices of the two materials should be small for high transmission in the pass state while maintaining high reflectance in the block state. The allowed magnitude of the y index mismatch can be described relative to the x index mismatch because the latter value suggests the number of layers used in the polarizer thin film stack to achieve a desired degree of polarization. The total reflectivity of a thin film stack is correlated with the index mismatch Δn and the number of layers in the stack N, i.e., the product (Δn)²xN correlates to the reflectivity of a stack. For example, to provide a film of the same reflectivity but with half the number of layers requires (2)112 times the index differential between layers, and so forth. The absolute value of the ratio Δn_{y}/Δnₓ is the relevant parameter that is desirably controlled, where Δn_{y}=n_{y1}−n_{y2} and Δnₓ=nₓ₁−nₓ₂ for first and second materials in an optical repeat unit as described herein. It is preferred that the absolute value of the ratio of Δn_{y}/Δnₓ is no more than 0.1, more preferably no more than 0.05, and even more preferably no more than 0.02, and, in some instance, this ratio can be 0.01 or less. Preferably, the ratio Δn_{y}/Δnₓ is maintained below the desired limit over the entire wavelength range of interest (e.g., over the visible spectrum). Typically, Δnₓ has a value of at least 0.1 and can be 0.14 or greater.

In many practical applications, a small z index mismatch between these layers is acceptable, depending on the angle the incident light makes to the film layers. However, when the film is laminated between glass prisms, i.e., immersed in a high index medium, the light rays are not bent toward the normal to the film plane. In this case, a light ray will sense the z index mismatch to a much greater degree compared to incidence from air, and a light ray of x-polarized light will be partially or even strongly reflected. A closer z index match may be preferred for light rays having a greater angle to the film normal inside the film. However, when the film is laminated between glass prisms having a lower index of refraction (e.g., n=1.60), the light rays are bent more toward the normal to the film plane; therefore, the light rays will sense the z index mismatch to a lesser degree. With the same z index mismatch, reflection of p-polarized will be generally lower when using low index prisms than when using high index prisms. Transmission of p-polarized light, therefore, may be higher when using low index prisms than when using a high index prism with the same films.

The allowed magnitude of the z index mismatch, like the y index mismatch, can be described relative to the x index mismatch. The absolute value of the ratio of Δn_{z}/Δnₓ is the relevant parameter that is desirably controlled, where Δn_{z}=n_{z1}−n_{z2} and Δnₓ=nₓ₁−nₓ₂ for first and second materials in an optical repeat unit as described herein. For a beamsplitter film intended for use in air, the absolute value of the ratio Δn_{z}/Δnₓ is preferably less than 0.2. For film immersed in a higher index medium such as glass, the absolute value of the ratio Δn_{z}/Δnₓ is preferably less than 0.1 and more preferably less than 0.05, and can be 0.03 or lower for incident light having a wavelength at 632.8 nm. Preferably, the ratio Δn_{z}/Δnₓ is maintained below the desired limit over the entire wavelength range of interest (e.g., over the visible spectrum). Typically, Anx has a value of at least 0.1 and can be 0.14 or greater at 632.8 nm.

The z index mismatch is irrelevant for the transmission of s-polarized light. By definition, s-polarized light does not sense the z-index of refraction of a film. However, as described in co-assigned U.S. Pat. No. 6,486,997 B1, entitled REFLECTIVE LCD PROJECTION SYSTEM USING WIDE-ANGLE CARTESIAN POLARIZING BEAM SPLITTER, the reflective properties of birefringent multilayer polarizers at various azimuthal angles are such that projection system performance is superior when the PBS is configured to reflect x-polarized (approximately s-polarized) light and transmit y-polarized (approximately p-polarized) light. The optical power or integrated reflectance of a multilayer optical film is derived from the index mismatch within an optical unit or layer pair, although more than two layers may be used to form the optical unit. The use of multilayer reflective films including alternating layers of two or more polymers to reflect light is known and is described, for example, in U.S. Pat. Nos. 3,711,176; 5,103,337; WO 96/19347; and WO 95/17303. The placement of this optical power in the optical spectrum is a function of the layer thicknesses. The reflection and transmission spectra of a particular multilayer film depends primarily on the optical thickness of the individual layers, which is defined as the product of the actual thickness of a layer and its refractive index. Accordingly, films can be designed to reflect infrared, visible, or ultraviolet wavelengths XM of light by choice of the appropriate optical thickness of the layers in accordance with the following formula:

λ_{M}=(2/M)*Dᵣ

wherein M is an integer representing the particular order of the reflected light and Dᵣ is the optical thickness of an optical repeating unit, which is typically a layer pair including one layer of an isotropic material and one layer of an anisotropic material. Accordingly, Dᵣ is the sum of the optical thicknesses of the individual polymer layers that make up the optical repeating unit. Dᵣ, therefore, is one half lambda in thickness, where lambda is the wavelength of the first order reflection peak. In general, the reflectance peak has finite band thickness, which increases with increasing index difference. By varying the optical thickness of the optical repeating units along the thickness of the multilayer film, a multilayer film can be designed that reflects light over a broad band of wavelengths. This band is commonly referred to as the reflection band or stop band. The collection of layers resulting in this band is commonly referred to as a multilayer stack. Thus, the optical thickness distribution of the optical repeat units within the multilayer film is manifested in the reflection and transmission spectra of the film. When the index matching is very high in the pass direction, the pass state transmission spectrum can be nearly flat and over 95% in the desired spectral range.

Various thickness distributions of optical thicknesses can be used in the films of the present invention. For example, the thickness distributions of one or both of the films can vary monotonically. In other words, the thickness of the optical repeating unit either shows a consistent trend of decreasing or increasing along the thickness of the MRP film (e.g., the thickness of the optical repeating unit does not show an increasing trend along part of the thickness of the multilayer film and a decreasing trend along another part of the multilayer film thickness).

Returning to FIG. 1, the first film 12 includes a plurality of layers that has a first distribution of optical thicknesses. Further, the second film 20 includes a plurality of layers that has a second distribution of optical thicknesses. The first and second distributions of optical thicknesses may be any suitable distributions known in the art. For example, the first and second distributions may include such distributions as those described in U.S. Pat. No. 6,157,490 entitled OPTICAL FILM WITH SHARPENED BANDEDGE. Further, for example, the first distribution may exhibit the same distribution of optical thicknesses as the second distribution. Alternatively, the first and second distributions may exhibit different distributions of optical thicknesses.

The films of the present invention may include thickness distributions that include one or more band packets. A band packet is a multilayer stack having a range of layer thickness such that a wide band of wavelengths is reflected by the multilayer stack. For example, a blue band packet may have an optical thickness distribution such that it reflects blue light, i.e., approximately 400 nm to 500 nm. MRP films of the present invention may include one or more band packets each reflecting a different wavelength band, e.g., an MRP having a red, green, and blue packet. MRP films of the present invention may also include UV and/or IR band packets as well. In general, blue packets include optical repeat unit thicknesses such that the packet tends to reflect blue light and, therefore, will have optical repeat unit thicknesses that are less than the optical repeat unit thicknesses of the green or red packets. The band packets can be separated within a film by one or more internal boundary layers.

Increasing the angle of incidence of light on a multilayer stack can cause the stack to reflect light of a shorter wavelength than when the light is incident normal to the stack. An IR packet may be provided to aid in reflecting red light for those rays that are incident on the stack at the highest angles.

As described in, for example, U.S. Pat. Nos. 5,882,774 and 5,962,114, MRP films have unique transmission or reflection spectra. As a result the different MRP films can exhibit different contrast ratios for different incident wavelengths and polarizations where the contrast ratio is defined as the ratio of transmitted intensities of the light with the desired transmission polarization (e.g., p-polarized light) over the light with the desired reflection polarization (e.g., s-polarized light). For example, the first film 12 may have a first contrast ratio spectrum, first transmission spectrum, or first reflection spectrum, and the second film 20 may have a second contrast ratio spectrum, second transmission spectrum, or second reflection spectrum. The first contrast ratio spectrum, first transmission spectrum, or first reflection spectrum may coincide with the second contrast ratio spectrum, second transmission spectrum, or second reflection spectrum, respectively, for a give wavelength band. Alternatively, the first contrast ratio spectrum, first transmission spectrum, or first reflection spectrum may be different from (and in some cases, spectrally shifted from) the second contrast ratio spectrum, second transmission spectrum, or second reflection spectrum, respectively, as is further described herein.

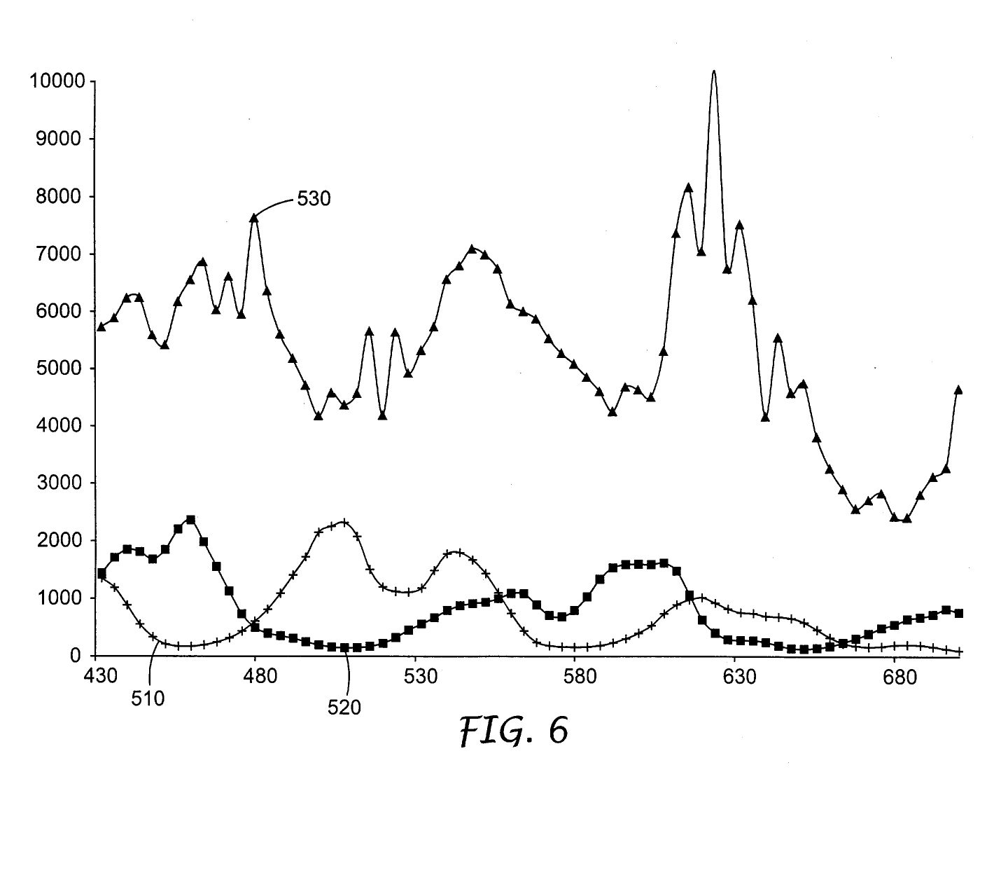

For example, FIG. 6 is a graph of contrast plotted against wavelength for a PBS having a first and second multilayer reflective polarizing film, both alone and in combination. As can be seen in FIG. 6, contrast ratio spectrum graph 520 (which represents film 4 as described herein) is shifted toward the red wavelengths from contrast ratio spectrum graph 510 (which represents film 3).

As is further illustrated in FIG. 1, the second film 20 is placed proximate the first film 12 such that a major surface 22 of the second film 20 faces a major surface 14 of the first film 12. The major surfaces 14 and 22 of the first and second films 12 and 20 that face each other may be in contact, or the major surfaces may be spaced apart with a spacer layer (e.g., optional layer 50) disposed between the first film 12 and the second film 20. The major surfaces 14 and 22 may be parallel as illustrated in FIG. 1.

Optional layer 50, which can be located between first film 12 and second film 20, may include an index matching fluid (such as an index matching oil) to aid in optically matching the two films 12 and 20 together. Any suitable type of matching oil may be utilized.

Optional layer 50 may include an optical adhesive. Any suitable optical adhesive may be used, e.g., thermally cured adhesive, pressure sensitive adhesive, etc. Optional absorbing adhesives or fluid to remove unwanted light may also be used in optional layer 50, e.g., UV-absorbing adhesives, IR-absorbing adhesives, etc.

The first and second films 12 and 20 are disposed between a first prism 30 and a second prism 40 which act as covers. Optionally, the first and second films 12 and 20 are adhered to the first and second prisms 30 and 40, respectively, using an adhesive. Although depicted as including two prisms 30 and 40, the PBS 10 may include any suitable covers disposed on either side of the first and second films 12 and 20.

The prisms 30 and 40 can be constructed from any light transmissive material having a suitable refractive index to achieve the desired purpose of the PBS. The prisms should have refractive indices less than that which would create a total internal reflection condition, i.e., a condition where the propagation angle approaches or exceeds 90° under normal usage conditions (e.g., where incident light is normal to the face of the prism). Such condition can be calculated using Snell's law. Preferably, the prisms are made of isotropic materials, although other materials can be used. A “light transmissive” material is one that allows at least a portion of incident light from the light source to transmit through the material. In some applications, the incident light can be pre-filtered to eliminate undesirable wavelengths. Suitable materials for use as prisms include, but are not limited to ceramic, glass, and polymers. A particularly useful category of glass includes glasses containing a metallic oxide such as lead oxide. A commercially available glass is PBH 55, available from Ohara Corporation (Rancho Santa Margarita, Calif., USA), having a refractive index of 1.85 and has about 75% lead oxide by weight. Because two or more films are being utilized in the PBS of the present invention, a lower index material may be used for prisms 30 and 40, e.g., SK5 glass made by Schott Corporation (Mainz, Germany).

For some MRP films, optical absorption may cause undesirable effects. To reduce optical absorption, the preferred multilayer stack is constructed such that wavelengths that would be most strongly absorbed by the stack are the first wavelengths reflected by the stack. For most clear optical materials, including most polymers, absorption increases toward the blue end of the visible spectrum. Thus, it may be preferred to tune the MRP film stack such that the “blue” layers, or packets, are on the incident side of the MRP film.

According to one embodiment of the present invention, a PBS (e.g., PBS 10 of FIG. 1) with equivalent performance independent of illumination side may be constructed by placing the red side of the first film 12 such that it faces the red side of the second film 20. In other words, the first thickness distribution of optical thicknesses (i.e., the thickness distribution of the first film), in general, has a blue region proximate a first major surface of the first film 12 and a red region proximate the second major surface of the first film 12. The blue region tends to reflect light in the blue wavelengths, and the red region tends to reflect light having red wavelengths. Similarly, the thickness distribution of optical repeat unit thicknesses of the second film 20 may have a blue region proximate a first major surface of the second film 20 and a red region proximate the second major surface of the second film 20. The films may be provided such that the second major surface of the first film 12 faces the second major surface of the second film 20. In other words, the red region of the first film 12 faces the red region of the second film 20. When constructed in this manner, the combination of the first film 12 and the second film 20 has a blue region facing out on both sides of the dual film; therefore, a blue region is always facing the incident light regardless of which surface of the composite first and second film is disposed facing the incident light. Although it may be preferred that the first and second films 12 and 20 are disposed such that the red region of the first film 12 faces the red region of the second film 20, the films may also be disposed such that the red region of one film faces the blue region of the other film, or the blue region of one film faces the blue region of the other film. Other arrangements of the films within the PBS can also be used.

Although the present invention provides polarizing beamsplitters that include two or more multilayer reflective polarizing films, and systems using such polarizing beamsplitters, the use of two or more MRP films, and particularly the use of two or more MZIP films, together can be used in other configurations or optical devices, e.g., brightness enhancement film constructions, polarizers, display applications, projection applications, and other optoelectronic applications. This combination of two or more MRP films (e.g., two or more MZIP films) can be used in general to increase the optical reflectance by closing spectral leaks arising either from the average placement of layers across the desired optical spectral band in the multilayer stack or by closing random spatial leaks, e.g., haze, superimposed on the band structure as for example by defects, as previously described herein. In the case of MZIP films, the combination can provide an increase in optical reflectance for one polarization, e.g. s-polarized light, without significant loss in transmission in the orthogonal state of polarization, e.g. p-polarized light, not only for normal incident but also for off-normal incident (“off-angle”) light. This is in distinct contrast to the combination of MRP films with significant z-index mismatch in which significant transmission losses can occur, often with resulting “off-angle” color. The advantages increase as the levels of y and z index matching improve. It is also advantageous to suppress surface reflections between the films, e.g., by eliminating the air layer between films by chemical or mechanical techniques such as lamination, by using a pass state index matching intermediate layer (again at a commensurate level of matching) such as an index matching fluid, or by using some other intermediate component.

One embodiment of the present invention may include a PBS having substantially right angle triangular prisms used to form a cube. In this case, the first and second films 12 and 20 are sandwiched between the hypotenuses of the two prisms 30 and 40 as described herein. A cube-shaped PBS may be preferred in many projection systems because it provides for a compact design, e.g., the light source and other components, such as filters, can be positioned so as to provide a small, light-weight, portable projector.

Although a cube is one embodiment, other PBS shapes can be used. For example, a combination of several prisms can be assembled to provide a rectangular PBS. For some systems, the cube-shaped PBS 10 may be modified such that one or more faces are not square. If non-square faces are used, a matching, parallel face can provided by the next adjacent component, such as the color prism or the projection lens.

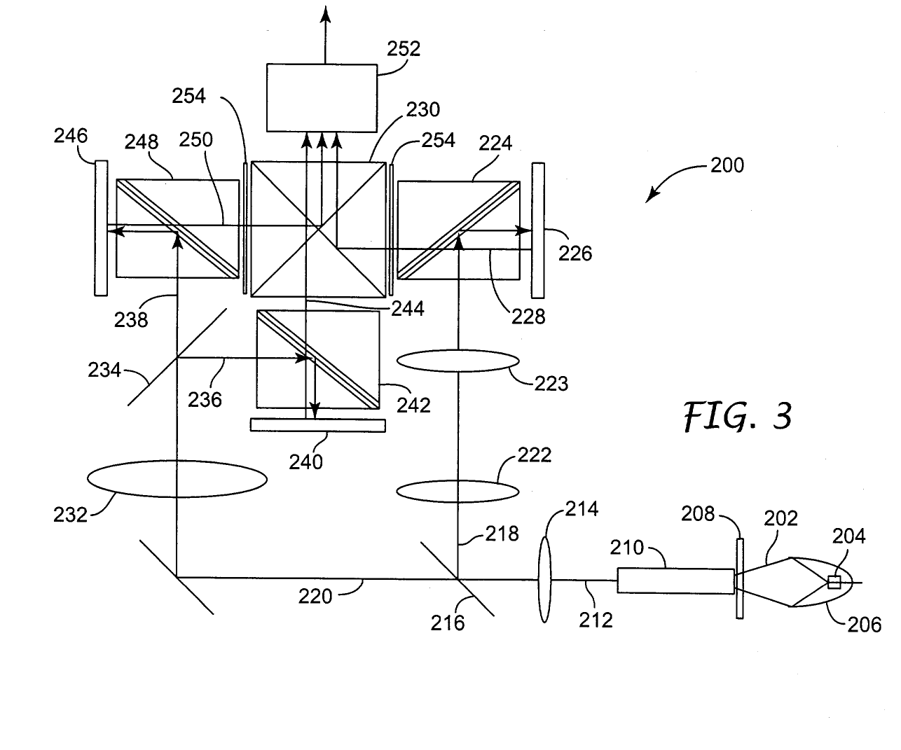

The prism dimension, and thus the resulting PBS dimension, depend upon the intended application. In an illustrative three panel LCoS light engine described herein in reference to FIG. 3, the PBS can be 17 mm in length and width, with a 24 mm height when using a small arc high pressure Hg type lamp, such as the UHP type sold commercially by Philips Corp. (Aachen, Germany), with its beam prepared as an F/2.3 cone of light and presented to the PBS cubes for use with 0.7 inch diagonal imagers with 16:9 aspect ratio, such as the imagers available from JVC (Wayne, N.J., USA), Hitachi (Fremont, Calif., USA), or Three-Five Systems (Tempe, Ariz., USA). The F# of the beam and imager size are some of factors that determine the PBS size.

The first and second films 12 and 20 may be disposed between the prisms 30 and 40 using any suitable technique known in the art, e.g., as described in co-assigned U.S. patent application Ser. No. 09/878,575, filed Jun. 11, 2001, entitled POLARIZING BEAM SPLITTER. For example, the first film 12 may be laminated or otherwise attached to the second film 20 prior to placing the first and second films 12 and 20 between the two prisms 30 and 40. Alternatively, the first film 12 may be attached to prism 30 and second film 20 attached to prism 40 and then the two films and their respective prisms brought together and attached using an optical adhesive.

As described herein, haze may be caused by various defects found within the multilayer reflective polarizing films of the present invention. For example, defects may be caused by various particulates that become trapped in between or within layers of the films. Further, localized voids may form during construction of the films. Another potential cause of defects may be delamination between one or more layers within the film. In addition, flow instabilities during co-extrusion may also cause defects. Finally, crystallites may form during construction of the films. Any defect within the film may cause one or more localized leaks of light that are polarized in the direction to be reflected (e.g., s-polarized light).

One possible purpose of the second film, as discussed herein, is to provide a measure of redundancy. By placing two films together to form a PBS, it is likely that the second film will contain one or more defects that do not coincide with the defects of the first film along the z direction. This blocking of defects may prevent s-polarized light from leaking through the films and into the projected image. Fewer leaks in turn increases contrast.

Further, as mentioned herein, the first film 12 may have a different contrast ratio spectra than the second film 20. For example, as described further herein, FIG. 6 is a graph of contrast (reported as a value of y: 1) plotted against wavelength for a PBS having a first and second multilayer reflective polarizing film, both alone and in combination. As further described in co-assigned, co-pending U.S. patent application Ser. No. 09/878,559, filed Jun. 11, 2001, entitled PROJECTION SYSTEM HAVING LOW ASTIGMATISM, contrast of a projection system is determined mostly by spectral light leaks in the multilayer structure. As can be seen in FIG. 6, contrast ratio spectrum 510 (which represents film 3) has a different contrast ratio spectrum than that of contrast ratio spectrum 520 (which represents film 4). For example, contrast ratio spectrum 510 exhibits good contrast in the approximately 430 nm to 480 nm range but exhibits poor contrast in the approximately 500 nm to 530 nm range. This poor contrast may be due to leakage of s-polarized light in that range. Contrast ratio spectrum 520, on the other hand, exhibits good contrast in the 480 nm to 580 nm range and poor contrast in the 430 nm to 480 nm range. In this particular example, contrast ratio spectrum 520 is shifted over from contrast ratio spectrum 510. As a result, the two films when combined produce surprisingly good contrast across the visible range. Thus, a PBS can be formed which has a contrast ratio of at least 500:1, 1000:1, or even 2000:1 over the visible spectral range (430-700 nm). The PBS also has a contrast ratio of at least 3000:1 over more than 80% of the visible spectral range.

The wavelength features (peaks and valleys) of the contrast ratio spectra of the films are determined by the layer thickness distribution. The positions of the peaks and valleys of the contrast ratio spectra are dependent on the optical repeat unit thicknesses and the distribution of layers within the film. Therefore, the peaks and valleys of the contrast ratio spectra can be shifted by varying the optical repeat unit thicknesses within the film.

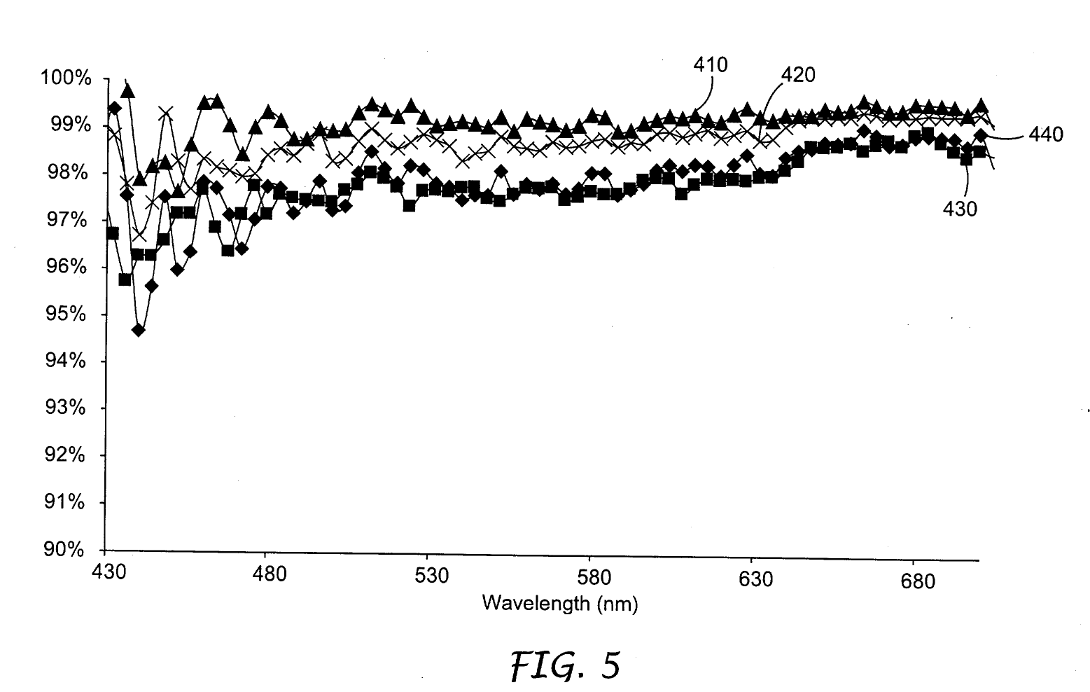

Also surprising is that the use of two or more films in a PBS does not appreciably reduce the desired transmission of light polarized by an imaging system. For example, as discussed in greater detail herein, FIG. 5 is a graph of transmission of p-polarized light plotted against wavelength for a PBS having a first and second multilayer reflective polarizing film, both alone and in combination. As can be seen in FIG. 5, the transmission of p-polarized light (Tₚ) remains above 95% over the visible spectral range (spectrum 430) and is greater than 96% and even 97% over 80% of the visible spectral range. In other words, the use of two or more films in a PBS may increase contrast while not substantially decreasing the desired transmission of p-polarized light. The p-polarized light transmission excludes absorption and reflection loss by the glass prisms.

Although FIG. 6 illustrates one embodiment of the present invention that includes two films having different contrast ratio spectra, another embodiment of the present invention may include two or more films that have substantially similar contrast ratio spectra.

The multifilm PBS of the present invention may be used in various optical imager systems. The term “optical imager system” as used herein is meant to include a wide variety of optical systems that produce an image for a viewer to view. Optical imager systems of the present invention may be used, for example, in front and rear projection systems, projection displays, head-mounted displays, virtual viewers, heads-up displays, optical computing systems, optical correlation systems, and other optical viewing and display systems.

One embodiment of an optical imager system is illustrated in FIG. 2, where system 110 includes a light source 112, for example an arc lamp 114 with a reflector 116 to direct light 118 in a forward direction. The light source 112 may also be a solid state light source, such as light emitting diodes or a laser light source. The system 110 also includes a PBS 120, e.g., the multifilm PBS described herein. Light with x-polarization, i.e., polarized in a direction parallel to the x-axis, is indicated by the circled x. Light with y-polarization, i.e., polarized in a direction parallel to the y-axis, is indicated by a solid arrow. Solid lines indicate incident light, while dashed lines indicate light that has been returned from a reflective imager 126 with a changed polarization state. Light provided by the source 112 is conditioned by conditioning optics 122 before illuminating the PBS 120. The conditioning optics 122 change the characteristics of the light emitted by the source 112 to characteristics that are desired by the projection system. For example, the conditioning optics 122 may alter any one or more of the divergence of the light, the polarization state of the light, the spectrum of the light. The conditioning optics 122 may include, for example, one or more lenses, a polarization converter, a pre-polarizer, and/or a filter to remove unwanted ultraviolet or infrared light.

The x-polarized components of the light are reflected by the PBS 120 to the reflective imager 126. The liquid crystal mode of reflective imager 126 may be smectic, nematic, or some other suitable type of reflective imager. If the reflective imager 126 is smectic, the reflective imager 126 may be a ferroelectric liquid crystal display (FLCD). The imager 126 reflects and modulates an image beam having y-polarization. The reflected y-polarized light is transmitted through the PBS 120 and is projected by a projection lens system 128, the design of which is typically optimized for each particular optical system, taking into account all the components between the lens system 128 and the imager(s). A controller 152 is coupled to the reflective imager 126 to control the operation of the reflective imager 126. Typically, the controller 152 activates the different pixels of the imager 126 to create an image in the reflected light.

An embodiment of a multi-imager projection system 200, is schematically illustrated in FIG. 3. Light 202 is emitted from a source 204. The source 204 may be an arc or filament lamp, or any other suitable light source for generating light suitable for projecting images. The source 204 may be surrounded by a reflector 206, such as an elliptic reflector (as shown) a parabolic reflector, or the like, to increase the amount of light directed towards the projection engine.

The light 202 is typically treated before being split into different color bands. For example, the light 202 may be passed through an optional pre-polarizer 208, so that only light of a desired polarization is directed towards the projection engine. The pre-polarizer may be in the form of a reflective polarizer, so that reflected light, in the unwanted polarization state, is redirected to the light source 204 for re-cycling. The light 202 may also be homogenized so that the imagers in the projection engine are uniformly illuminated. One approach to homogenizing the light 202 is to pass the light 202 through a reflecting tunnel 210, although it will be appreciated that other approaches to homogenizing the light may also be employed.

In the illustrated embodiment, the homogenized light 212 passes through a first lens 214 to reduce the divergence angle. The light 212 is then incident on a first color separator 216, which may be, for example, a dielectric thin film filter. The first color separator 216 separates light 218 in a first color band from the remaining light 220.

The light 218 in the first color band may be passed through a second lens 222, and optionally a third lens 223, to control the size of the light beam 218 in the first color band incident on the first PBS 224. The light 218 passes from the first PBS 224 to a first imager 226. The imager reflects image light 228 in a polarization state that is transmitted through the PBS 224 to an x-cube color combiner 230. The imager 226 may include one or more compensation elements, such as a retarder element, to provide additional polarization rotation and thus increase contrast in the image light.

The remaining light 220 may be passed through a third lens 232. The remaining light 220 is then incident on a second color separator 234, for example a thin film filter or the like, to produce a light beam 236 in a second color band and a light beam 238 in a third color band. The light 236 in the second color band is directed to a second imager 240 via a second PBS 242. The second imager 240 directs image light 244 in the second color band to the x-cube color combiner 230.

The light 238 in the third color band is directed to a third imager 246 via a third PBS 248. The third imager 246 directs image light 250 in the third color band to the x-cube color combiner 230.

The image light 228, 244 and 250 in the first, second and third color bands is combined in the x-cube color combiner 230 and directed as a full color image beam to projection optics 252. Polarization rotating optics 254, for example half-wave retardation plates or the like, may be provided between the PBSs 224, 242 and 248 and the x-cube color combiner 230 to control the polarization of the light combined in the x-cube color combiner 230. In the illustrated embodiment, polarization rotating optics 254 are disposed between the x-cube color combiner 230 and the first PBS 224 and third PBS 248. Any one, two, or all three of PBSs 224, 242, and 248 may include two or more MRP films as described herein.

It will be appreciated that variations of the illustrated embodiment may be used. For example, rather than reflect light to the imagers and then transmit the image light, the PBSs may transmit light to the imagers and then reflect the image light. The above described projection systems are only examples; a variety of systems can be designed that utilize the multifilm PBSs of the present invention.

### EXAMPLES

The films of the following examples are similar in construction and processing, essentially varying only through their final thickness and through secondary variations resulting from the use of different casting speeds needed to achieve these varying thicknesses at constant melt pumping rates. The films are designated films 1-4. The films were extruded and drawn in accordance with the general methods described in U.S. patent application Ser. No. 09/878,575, filed Jun. 11, 2001, entitled POLARIZING BEAM SPLITTER.

A copolyester, conveniently labeled as coPET, for use as the low index layer in the multilayer film, was synthesized as follows. The following components were charged into a 100 gallon batch reactor: 174.9 lbs 1,4-dimethyl terephthalate, 69.4 lbs 1,4 dimethyl cyclohexanedicarboxylate, 119.2 lbs 1,4-cyclohexane dimethanol, 36.5 lbs neopentyl glycol, 130 lbs ethylene glycol, 1200 g trimethylol propane, 23 g cobalt acetate, 45 g zinc acetate, and 90 g antimony acetate. Under pressure of 0.20 MPa, this mixture was heated to 254° C. while removing methanol. After 80 lbs of methanol was removed, 64 g of triethyl phosphonoacetate was charged to the reactor and then the pressure was gradually reduced to 2 mm Hg while heating to 285° C. The condensation reaction by-product, ethylene glycol, was continuously removed until a polymer with an intrinsic viscosity of 0.74 dL/g, as measured in 60/40 wt. % phenol/o-dichlorobenzene, was produced. The Tg of the coPET was measured to be 64° C. by Differential Scanning Colorimetry (DSC). The refractive index of the material at 632.8 nm was measured as 1.541 using a Metricon Prism coupler as available from Metricon, Piscataway, N.J.

A multilayer film containing 892 layers was made via a coextrusion and orientation process wherein the PET was the first, high index material and the coPET described above was the second, low index material. A feedblock method (such as that described by U.S. Pat. No. 3,801,429) was used to generate about 223 layers with a layer thickness range sufficient to produce an optical reflection band with a fractional bandwidth of 30%. An approximate linear gradient in layer thickness was produced by the feedblock for each material with the ratio of thickest to thinnest layers being 1.30.

PET with an initial intrinsic viscosity (IV), e.g., of 0.74 dl/g PET 7352, as available from Eastman Chemical Company (Kingsport, Tenn., USA), was fed into an extruder and delivered to the feedblock at a rate of 50 kg/hr, and coPET was delivered by another extruder at 43 kg/hr.

These meltstreams were directed to the feedblock to create 223 alternating layers of PET and coPET with the two outside layers of PET serving as protective boundary layers (PBL) through the feedblock. The PBLs were much thicker than the optical layers, the former containing about 20% of the total meltflow of the PET (10% for each side).

The material stream then passed though an asymmetric two times multiplier (as described in U.S. Pat. Nos. 5,094,788 and 5,094,793). The multiplier thickness ratio was about 1.25:1. Each set of 223 layers has the approximate layer thickness profile created by the feedblock, with overall thickness scale factors determined by the multiplier and film extrusion rates. The material stream then passed though a second asymmetric two times multiplier with a multiplier ratio of about 1.55:1. The final layer distribution was thus a composite of four packets, the average spectral separation of these packets having a bearing on the block state leak structure.

After the multipliers, outside skin layers of polypropylene (PP) (Atofina Petrochemicals, Inc., Monrovia, Calif., USA, Product No. 8650) were added to the meltstream. The PP was fed to a third extruder at a rate of 24 kg/hour. Then the material stream passed through a film die and onto a water-cooled casting wheel. The inlet water temperature on the casting wheel was 8° C. A high voltage pinning system was used to pin the extrudate to the casting wheel.

The casting wheel speed was adjusted for precise control of final film thickness. In this manner, the various pre-cursor un-oriented cast webs were made for films 1-4. For example, using the casting wheel speed of film 1 as a reference, the ratio of speeds used to form films 2-4 were 0.77, 1.21, and 1.06 respectively, thereby approximately changing the thicknesses of these films relative to film 1 by the reciprocals of these ratios. In this manner, the spectral shape of the layer distribution is approximately maintained while the distribution is changed by varying its spectral centering.

The PP extruder and associated melt process equipment were maintained at 254° C. The PET and coPET extruders, the feedblock, skin-layer modules, multiplier, die, and associated melt process equipment were maintained between 266° C. and 282° C.

The cast precursor web were cut into 18 cm by 25 cm sheets (MD x TD in which MD is the original direction of film casting and TD the direction transverse to it), and these sheets were equilibrated at 50% R. H. and room temperature before stretching. After equilibration, the samples were fed into a standard film tenter for uniaxial stretching. The cast web piece was gripped by the tenter clips on the edges as for continuously oriented films. The film near the clips cannot contract in the MD because the spacings between the tenter clips are fixed. But because the web was not constrained on the leading and trailing edges, it contracted in the MD, the contraction being larger the greater the distance from the clips. With large enough aspect ratios, the center of the sample is able to fully contract for a true uniaxial orientation, i.e., where the contraction was equal to the square root of the TD stretch ratio. The films were fed with their long (25 cm) direction in TD into the tenter set at a temperature of 98° C. The films were drawn to a final nominal draw ratio 6.5 after a brief overshoot to a nominal draw ratio of 7. The final draw ratio was slightly higher in the central portion of the part due to slightly less drawing near the clips, actively cooled to 52° C. The films were generally drawn so that the MD index (e.g., y direction index) of refraction of the PET PBL, as measured on the final stretched part using the Metricon Prism Coupler, closely matched the amorphous index of the coPET, e.g., 1.541+/−0.002 at 632.8 nm. The z direction index of the PET PBL was likewise closely matched, about 1.540 at 632.8 nm. Finally, the dispersion curves of the PET y, z, and coPET isotropic indices were reasonably similar over the visible spectrum to nearly maintain this level of index matching through the blue portion of the spectrum (e.g., 430 nm). The inlet feed speed, providing initial strain rates in the range of 0.05 to 1 sec⁻¹, was used to control the final refractive index and ensure the index matching. The resulting films 1-4 had nearly identical refractive indices in their PET PBLs, (measuring 1.698, 1.701, 1.697, and 1.699, respectively, for 632.8 nm light polarized along TD) after drawing. The example films 1-4 varied by their final thickness, with PP skins peeled off, with measured values of 120, 160, 96, and 114 micrometers respectively.

In order to test the effects of double layers of PBS film in different glasses, the needed PBSs were constructed by use of index matching oil (index selected to match that of the film in transmission) and glass prisms of the desired type. The index oil used was LASER LIQUID from Cargille (Cedar Grove, N.J., USA) with an index of n=1.5700, while the glass prisms used was SK5 glass Schott Corporation (Meinz, Germany) having an index of refraction about 1.59. These were tested in an f/2 beam of light using a High Pressure Hg lamp, tunnel integrator, and appropriate lenses and color filters to focus the light onto a test mirror as described, e.g., in U.S. Pat. No. 6,486,997 B1.

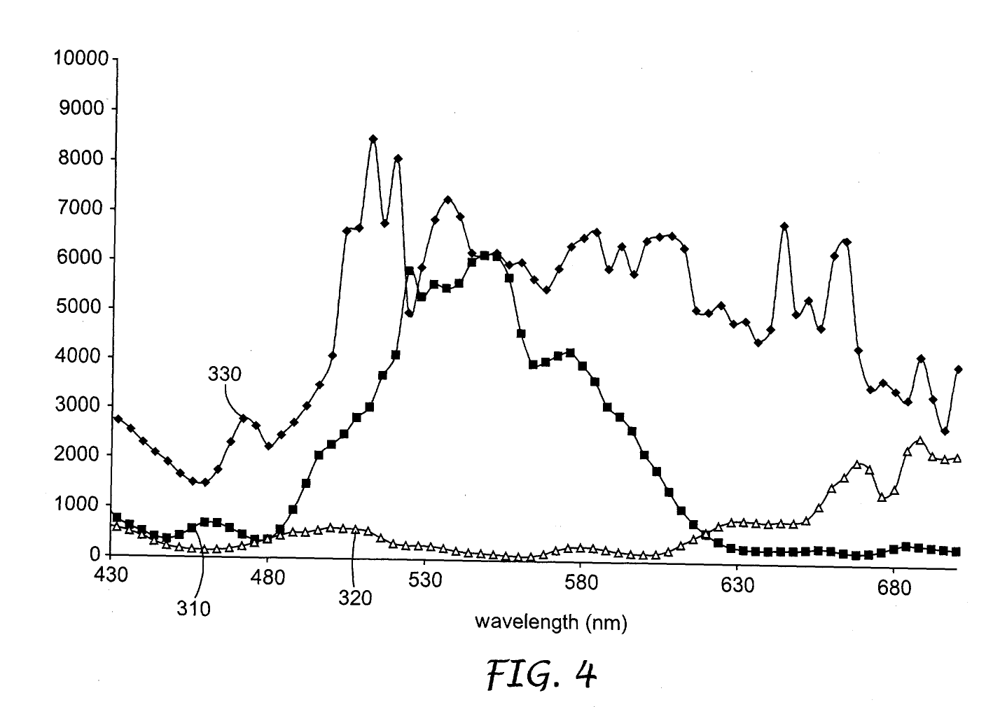

A double laminate was then constructed with two films placed on the hypotenuse of the PBS prisms with index matching oil between them. These films were not designed for optimum performance in this configuration, but quite good performance over the entire visible band was achieved with film 1 and film 2. The contrast ratio plot for this combination is shown in FIG. 4.

In FIG. 4, films 1-2 are plotted individually and in combination. Film 1 is represented as spectrum 310, film 2 as spectrum 320, and the combination of film 1 and film 2 as spectrum 330. As can be observed, the combination of film 1 and film 2 in the same PBS provides a higher contrast across the visible wavelength range than the two films provide individually. For example, a PBS including film 1 provides a contrast ratio of approximately 4000:1 at 580 nm, while film 2 provides a contrast of less than 100:1 at 580 nm. However, the combination of films 1-2 provides a contrast ratio of over 6000:1 at 580 nm.

It is desirable to have very high transmission of p-polarized light (Tₚ) in the PBS. This not only gives higher light efficiency in the projection engine, it also allows the designer to relax requirements on the polarization purity of the input beam, thereby reducing costs and increasing efficiency.

As illustrated in FIG. 5, the transmission of p-polarized light (Tₚ) for film 1 in SK5 glass (spectrum 410) provides a transmission of around 99%. FIG. 5 also includes Tₚ for film 2 in SK5 glass (spectrum 420). Also plotted is the transmission of the combination of film 1 and film 2 in a single PBS (spectrum 430). This combination is compared with the product of the individual transmission values of film 1 and film 2 (spectrum 440). As can be seen in FIG. 5, the combination of film 1 and film 2 (spectrum 430) provides the same transmission of p-polarized light as does the product of the transmissions for the individual films (spectrum 440).

Tests were also performed on a PBS having film 3 and film 4 with matching oil in SK5 glass. This PBS was also tested in an f/2 beam of light using a High Pressure Hg lamp, tunnel integrator, and appropriate lenses and color filters to focus the light onto a test mirror. A double laminate of film 3 and film 4 was also constructed with the laminate placed on the hypotenuse of the PBS prisms with index matching oil between the two films. The contrast ratio plot for each individual film and the laminate is shown in FIG. 6.

As can be seen in FIG. 6, film 3 has a different contrast ratio spectrum (510) than that of film 4 (520) such that the spectrum of film 4 is shifted toward the red wavelengths. The combination of film 3 and film 4 (spectrum 530) provides a much higher contrast across the entire visible wavelength band than each film individually. For example, both film 3 and film 4 individually provide a contrast ratio spectrum with less than 1000:1 contrast at a 580 nm wavelength. A PBS having both film 3 and film 4 in combination provides a contrast of over 5000:1 at a 580 nm wavelength. In other words, FIG. 6 clearly shows that a laminate of two different MRP films (i.e., film 3 and film 4) can provide dramatically improved contrast across the visible without the use of a high index glass in the PBS prisms.

All references and publications cited herein are expressly incorporated herein by reference in their entirety into this disclosure. Illustrative embodiments of this invention are discussed and reference has been made to possible variations within the scope of this invention. These and other variations and modifications in the invention will be apparent to those skilled in the art without departing from the scope of this invention, and it should be understood that this invention is not limited to the illustrative embodiments set forth herein. Accordingly, the invention is to be limited only by the claims provided below.

What is claimed is:

1. A polarizing beamsplitter, comprising:
a first multilayer reflective polarizing film comprising a plurality of layers, wherein the plurality of layers has a first distribution of optical thicknesses;
a second multilayer reflective polarizing film proximate the first multilayer reflective polarizing film, wherein the second multilayer reflective polarizing film comprises a plurality of layers, wherein the plurality of layers has a second distribution of optical thicknesses, wherein the second distribution is different than the first distribution, and further wherein a major surface of the second multilayer reflective polarizing film faces a major surface of the first multilayer reflective polarizing film; and
covers disposed on either side of the first and second multilayer reflective polarizing films.

2. The polarizing beamsplitter of claim 1, wherein the covers are prisms.

3. The polarizing beamsplitter of claim 2, wherein the covers are glass prisms.

4. The polarizing beamsplitter of claim 1, wherein the polarizing beamsplitter further comprises an optical adhesive between the first multilayer reflective polarizing film and the second multilayer reflective polarizing film.

5. The polarizing beamsplitter of claim 1, wherein the polarizing beamsplitter further comprises an index matching fluid between the first multilayer reflective polarizing film and the second multilayer reflective polarizing film.

6. The polarizing beamsplitter of claim 1, wherein the first multilayer reflective polarizing film comprises a first contrast ratio spectrum and the second multilayer reflective polarizing film comprises a second contrast ratio spectrum, and further wherein the first contrast ratio spectrum is different from the second contrast ratio spectrum.

7. The polarizing beamsplitter of claim 1, wherein the first and second multilayer reflection polarizing films are matched z-index polarizer films.

8. The polarizing beam splitter of claim 1, wherein the contrast ratio of the polarizing beam splitter is at least 500:1 over the visible spectral range.

9. The polarizing beam splitter of claim 1, wherein the contrast ratio of the polarizing beam splitter is at least 2000:1 over the visible spectral range.

10. The polarizing beam splitter of claim 1, wherein reflectance of p-polarized light is at least 94% over the visible spectral range.

11. A polarizing beamsplitter, comprising:
a first multilayer reflective polarizing film;
a second multilayer reflective polarizing film proximate the first multilayer reflective polarizing film, wherein a major surface of the second multilayer reflective polarizing film faces a major surface of the first multilayer reflective polarizing film; and
covers disposed on either side of the first and second multilayer reflective polarizing films.

12. The polarizing beamsplitter of claim 11, wherein the covers are prisms.

13. The polarizing beamsplitter of claim 12, wherein the covers are glass prisms.

14. The polarizing beamsplitter of claim 11, wherein the polarizing beamsplitter further comprises an optical adhesive between the first multilayer reflective polarizing film and the second multilayer reflective polarizing film.

15. The polarizing beamsplitter of claim 11, wherein the polarizing beamsplitter further comprises an index matching oil between the multilayer reflective polarizing film and the second multilayer reflective polarizing film.

16. A projection system, comprising:
a light source to generate light;
conditioning optics to condition the light from the light source;
an imaging core to impose an image on conditioned light from the conditioning optics to form image light, wherein the image core comprises at least one polarizing beamsplitter and at least one imager, wherein the polarizing beamsplitter comprises:
a first multilayer reflective polarizing film;
a second multilayer reflective polarizing film proximate the first multilayer reflective polarizing film, wherein a major surface of the second multilayer reflective polarizing film faces a major surface of the first multilayer reflective polarizing film; and
covers disposed on either side of the first and second multilayer reflective polarizing films; and
a projection lens system to project the image light from the imaging core.

17. The system of claim 16, wherein the first multilayer reflective polarizing film lies in an x-y plane and has a thickness in a z-direction, and further wherein the first multilayer reflective polarizing film has a z-refractive index substantially matched to the y-refractive index.

18. The system of claim 16, wherein the second multilayer reflective polarizing film lies in an x-y plane and has a thickness in a z-direction, and further wherein the second multilayer reflective polarizing film has a z-refractive index substantially matched to the y-refractive index.

19. The system of claim 16, further comprising a controller coupled to the at least one imager to control the image imposed on light incident on the at least one imager.

20. The system of claim 16, wherein the polarizing beamsplitter is a Cartesian polarizing beamsplitter having a structural orientation defining fixed axes of polarization and the light conditioning optics having an f-number equal to or less than 2.5, wherein the system has a dynamic range of at least 100 to 1 over projected color bands in the visible light range.

21. The system of claim 16, wherein the imaging core is telecentric.

22. The system of claim 16, further comprising a color separator disposed between the polarization beamsplitter and the at least one imager.

23. A method of making a polarizing beamsplitter, the method comprising:
forming a first multilayer reflective polarizing film;
forming a second multilayer reflective polarizing film;
placing a major surface of the second multilayer reflective polarizing film opposite a major surface of the first multilayer reflective polarizing film; and
placing the first and second multilayer reflective polarizing films between two covers.
